(19) United States
(12) Patent Application Publication
(10) Pub. No.: US 2015/0205962 A1
(43) Pub. Date: Jul. 23, 2015

(54) BEHAVIORAL ANALYTICS DRIVEN HOST-BASED MALICIOUS BEHAVIOR AND DATA EXFILTRATION DISRUPTION

(71) Applicant: CYLENT Systems, Inc., Boston, MA (US)

(72) Inventors: Kirk R. Swidowski, Manteca, CA (US); Kara A. Zaffarano, Rome, NY (US); Jason M. Syversen, Dunbarton, NH (US); Joseph J. Sharkey, Utica, NY (US); John J. Danahy, Bow, NH (US); Ryan J. Berg, Austin, TX (US)

(73) Assignee: CYLENT SYSTEMS, INC., Boston, MA (US)

(21) Appl. No.: 14/602,011

(22) Filed: Jan. 21, 2015

Related U.S. Application Data
(60) Provisional application No. 61/930,931, filed on Jan. 23, 2014.

(51) Int. Cl. G06F 21/56

(52) U.S. Cl. CPC G06F 21/566; G06F 2221/033; G06F 2221/034

(57) ABSTRACT

A system and method detects the existence of malicious software on a local host by analysis of software process behavior including user input events and system events. A user validation engine provides user notification. In-VM operating system monitors capture events handled by the OS, capture user input from the HMI devices, and capture system events from applications executed by the processor at hardware, kernel and/or API levels. The In-VM operating system monitors also pass captured user input and system events to the user validation engine for analysis. The user validation engine identifies legitimate user events as those that move from the hardware level upward to pre-selected applications, identifies illegitimate user events as those that start at the kernel and/or API levels, and approves communication for legitimate events while denying communication for illegitimate events.

### RELATED APPLICATION

This application claims the benefit of U.S. Provisional Patent Application Ser. No. 61/930,931, entitled HOST-BASED DATA EXFILTRATION DETECTION, filed on Jan. 23, 2014, the contents of which are incorporated herein by reference in their entirety for all purposes.

### REFERENCE TO GOVERNMENT FUNDING

This invention was made with government support under contract number W911NF-11-C-0009 awarded by the U.S. Army Research Office. The Government has certain rights in this invention.

### BACKGROUND

### Technical Field

This invention relates to computer system security, and more particularly, to a system and method for automatically detecting and disrupting the activities of malicious software (malware), including by not limited to, the attempted unauthorized exfiltration of data, based on an analysis and correlation of user input, operating system, and hardware events.

Malicious software applications (e.g., spyware, botnets, remote administration Trojans, keyloggers, peer-to-peer file sharing, remote monitoring and control software) constitute a serious threat to organizational data privacy and security because they compromise systems within protected networks, collecting information and then surreptitiously sending that information outside of that network. Malware runs at various privilege levels on an infected system, from user to kernel space, and may disable or bypass on-host security mechanisms. Network security appliances (e.g., firewalls and network intrusion detection systems) that focus on traffic analysis are of limited help in detecting and mitigating information leakage from compromised computers because the actual data transfers look the same, whether initiated by a user or by the malicious code.

Existing anti-spyware and anti-virus systems have difficulty in reliably finding and stopping malicious code because malware is often written to corrupt the operating system kernel, disabling or redirecting on-host security systems. The result of these technological limitations is that existing technologies leave sensitive data vulnerable to exfiltration by malicious software. This is an unacceptable risk for government and enterprise organizations.

### SUMMARY

An aspect of the invention includes a system for detecting the existence of malicious software on a local host based on an analysis of software process behavior including an analysis of user input events with respect to system events. The system includes a computer including a processor, a memory, an operating system (OS), and one or more Human Machine Interface (HMI) devices, the computer having a hardware level communicably coupled to the HMI devices, a kernel process level within the OS, and an Application/Application Programming Interface (API) level for executing applications. A user interface application includes a user validation engine executable by the processor to provide user notification, interaction and analysis. One or more In-VM operating system monitors communicably coupled to the OS is configured to capture input and communication events handled by the OS. The In-VM operating system monitors are configured to capture user input from the HMI devices, and to capture system events from applications executed by the processor, at one or more points at the hardware level, the kernel process level, and/or the API level. The In-VM operating system monitors are also configured to pass the captured user input and system events to the user validation engine for analysis. The user validation engine identifies legitimate user events as those that start at the hardware level and move upward to one or more pre-selected applications, identifies illegitimate user events as those that start at the kernel process level and/or the API level, and also approves communication for legitimate user events while denying communication for illegitimate user events.

In another aspect of the invention, a method for detecting exfiltration of data is based on an analysis of user input events with respect to system events. The method includes using the aforementioned system to capture, with the In-VM operating system monitors, user input from the HMI devices, and system events from applications executed by the processor, at one or more points at the hardware level, the kernel process level, and/or the API level. The In-VM operating system monitors pass the captured user input and system events to the user validation engine for analysis. The user validation engine identifies legitimate user events as those that start at the hardware level and move upward to one or more pre-selected applications, identifies illegitimate user events as those that start at the kernel process level and/or the API level, and approves communication for legitimate user events while denying communication for illegitimate user events.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

The present invention is illustrated by way of example and not limitation in the figures of the accompanying drawings, in which like references indicate similar elements and in which:

FIG. 1 is a functional block diagram of one embodiment of a system of the present invention;

FIG. 2 is schematic diagram of aspects of the embodiment of FIG. 1;

FIG. 3 is a functional block diagram illustrating event movement in the embodiments of FIGS. 1 and 2;

FIG. 4 is a high level functional block diagram of aspects of the embodiment of FIG. 1;

FIG. 5 is a diagram similar to that of FIG. 1, with additional detail;

FIG. 6 is a flow chart of an embodiment of a method in accordance with the present invention; and

FIG. 7 is a flow chart of an alternate embodiment of the present invention.

### DETAILED DESCRIPTION

The systems and methods described herein are used to automatically detect and disrupt the activities of malicious software (malware), including by not limited to the attempted unauthorized exfiltration of data, based on an analysis and correlation of user input and system events.

Malicious software running on compromised systems within an internal network has the ability to gather information and surreptitiously send it to unauthorized systems and external networks, posing a significant threat to the confidentiality of critical information. It also has sufficient privileges to cause damage through the unauthorized encryption or destruction of valuable data. To address this deficiency, new techniques and implementations are needed to monitor program and user activities on systems to detect and disrupt unauthorized activities, including these unauthorized activities involving system data and traffic.

Capabilities are required that can provide real-time automatic identification and mitigation of information leaks, prevent unwanted and malicious traffic from exiting the computer, and disrupt destructive activities within the system.

The system described herein includes an automated, real-time, solution to detect and disrupt malware, including, but not limited to, data theft. Embodiments of the system described herein have been demonstrated identify the existing of malicious software and to stop data theft by a range of arbitrary malware samples, including, as non-limiting examples, Koobface, FakeAV and Stuxnet. The system identifies malicious software through behavioral analysis and helps prevent said software from exfiltrating information using new technical approaches to monitor applications and user activities on a computer. Using these methods, the system can detect outgoing data and traffic requests that are not initiated or authorized by the user. This capability also detects so-called “0-day” attacks when those attacks attempt to access or exfiltrate files from the target system.

In some embodiments, the system can also be configured to detect and prevent malicious software by correlating user events with system events (such as network communications activity), thereby identifying suspicious outgoing connections. Examples of different types of user events are provided below.

In some embodiments, the system may include a low-level CPU and system monitoring solution called a hypervisor (optionally, for event verification), a user interface application (for notification and interaction), and one or more operating system monitors (for capturing input and communication events).

In some embodiments, the system may be configured to disrupt malicious behaviors that are local to the machine, but which are subject to, and identified by, command and control from an external source through the disruption of communication and network connection between the affected machine and the established malicious software command and control channel. In other words, once the user validation engine distinguishes between legitimate communications connections intended by the user and automated communications connections established by malicious programs, it may then prevent incoming traffic or data transfers to the malicious programs.

The hypervisor is an optional component and is not provided or implemented in some embodiments. While the description herein is made with reference to a hypervisor, the hypervisor could be implemented with any component that can be configured to validate user input events and/or provide protection for the exfiltration sensor/actuator suite against malicious actors who are assumed to have kernel-level privileges. A malicious attacker could use those privileges to spoof the sensor, or disable the response mechanism without proper safeguards in place (running in special hardware, privileged operating conditions such as a hypervisor, SMM, or other privileged mode).

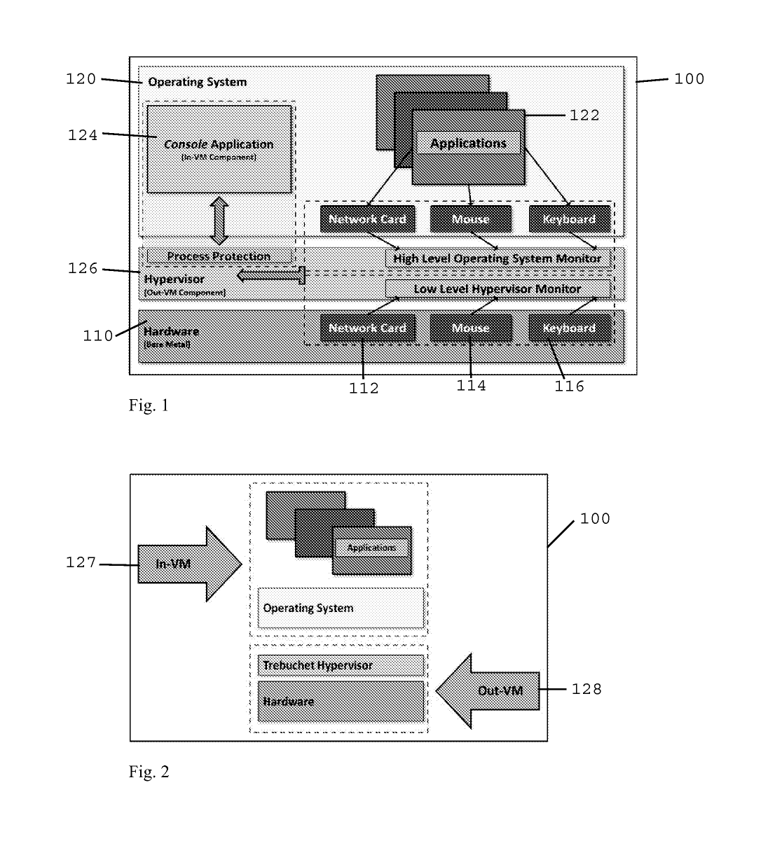

Components may communicate with one another through a shared interface which allows for the transfer of communication and input events to be analyzed. FIG. 1 depicts the overall architecture of an example embodiment, in which a system 100 includes a hardware layer 110, which may include a network card 112, mouse 114 and/or a keyboard 116. System 100 also includes an Operating System (OS) 120 to interface with the hardware layer 110 and with an application layer 122. A user interface application including a user validation engine, is shown at 124. As used herein, In-VM refers to software running in the context of a virtual machine, or in the system's host operating system (OS). Out-VM refers to hardware (with or without associated software) running outside of a virtual machine or out-of-band for the system's host OS. As used herein, the term data can refer to any machine readable information, including program code, instructions, user files, URLs, etc., without limitation.

In this example implementation, In-VM monitoring techniques are used to monitor specified OS application programming interfaces (identified OS APIs) that are directly related to expected data transfer or process control operations. These techniques are leveraged to provide necessary information to generate context and substantiation for user identification and exfiltration detection. An optional thin hypervisor (or other hardware-enforced sub-kernel level enabling technology) 126 can be used to provide hardware input/output (I/O) monitoring and hypervisor-assisted protection for in-VM components. Alternatively the detection system could reside in kernel memory, without a hypervisor. In those embodiments, the system can include additional protections from attackers who may have kernel privileges. Thus, while some examples herein may illustrate and describe the use of in-VM and hypervisor components, those components are not required for successful implementation and operation of the system.

Within the example implementation, the user interface application is used for configuration, control, and analysis of the data gathered by the monitoring and hypervisor components. In order to provide visibility into application behaviors and to ensure that the solution is tamper-resistant, both in-VM and/or Out-VM components are used. The In-VM components provide the ability to monitor an OS-level API, while the Out-VM components provide additional security and protection that is inaccessible to kernel-level processes.

User events can also be captured. Events take multiple forms as inputs, including, as non-limiting examples, keyboard, mouse, touchscreen, touchpad, accelerometer, and/or proximity sensor inputs. As shown in FIG. 2, these inputs can be captured at a variety of levels. As non-limiting examples, user input can be captured at both the hardware level (Out-VM monitor) and at the process level (In-VM monitor). System events (such as network or process communication events) can be captured at the API level (In-VM monitor) and may be associated with existing communication channels. When events are captured from the In-VM components, as shown at 127, including user input or communication events, they can be passed, as context for additional input or later analysis, to the optional hypervisor (or other Out-VM component) as shown at 128. An example of a hypervisor usable in embodiments of the instant invention is the Trebuchet™ hypervisor commercially available from Siege Technologies (540 North Commercial Street, Manchester NH 03101).

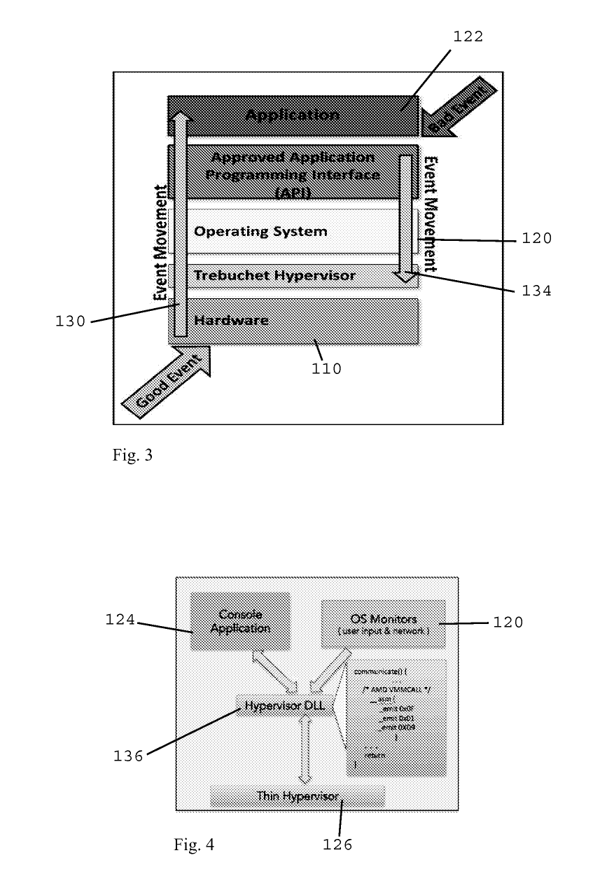

Referring now to FIG. 3, as a non-limiting example, the two-level approach can be used in connection with user input to demonstrate adherence to an expected level movement model in order to characterize a legitimate event that appears in a request for some activity. Using mouse movement and clicks as an example, these events may be deemed valid when they start at the hardware device layer 110 and move directly upward to the appropriate active application, as shown at 130. In contrast, a forged event will likely be created at the application (including Application Programming Interfaces) layer 122 or operating system level 120, and will not follow the same, direct and upward movement path, e.g., moving downward as shown at 134. This difference will make the event non-verifiable and may in turn trigger additional checks, or may immediately be considered a malicious event.

The user interface application regularly requests event and verification information from the hypervisor or Out-VM components.

Once an event reaches the hypervisor or other Out-VM components, additional verification data can be appended and the event can be stored until the user interface application requests it. The user interface application can be configured to repeatedly or regularly poll for events from Out-VM components on a set or predetermined interval. When a new event is available, it is retrieved and analyzed.

During analysis performed by the user interface application, the event is associated with a particular process, and the system then determines whether that event is actually driven by the user by querying for any corresponding input event from any HMI (Human Machine Interface) hardware component. If the correlation exists, then the event is verified as real, or user/hardware initiated. If there is no corresponding activity from any HMI, the event is flagged as non-user initiated, and the process is then denied for whatever requested activity was pending.

Having provided a brief overview, various embodiments will now be described in greater detail.

As discussed above, embodiments of the invention monitor user events and system events to determine if there is a sufficient correlation between the two to verify the validity of the attempted user event or input. As a non-limiting example, the system can monitor HMI devices to confirm whether or not communication activity is initiated by the user. This monitoring allows the detection algorithm to distinguish between legitimate communications connections intended by the user and automated communications connections established by malicious programs. The system uses this approach to detect communications attempts and then to prevent outgoing traffic or data transfers that are not initiated or authorized by an actual user controlled process.

As used herein, an HMI device can be any type of Human Machine Interface. As non-limiting examples, the human machine interface being monitored could be a keyboard, mouse, touchscreen, touchpad track pad, membrane switch, kinetic or inertial device, accelerometer, proximity sensor, or any other type of device though which a user interacts with a computing device. The output of any interaction of a user with the system though any HMI device is referred to herein as a user event. While some examples herein may specifically refer to a mouse or keyboard, it is understood that those devices are identified only as examples and that any other appropriate HMI device could be substituted in lieu of the example device.

As used herein, a system event can include any inter-device communications by any network, Bluetooth, NFC, IrDA, file system input/output (e.g., hard drive access), active windows, files accessed, API calls related to functions, interprocess communications, or others.

In one embodiment, the system can be implemented as a software application running with kernel privileges and is appropriate to the protection of a wide variety of otherwise unenhanced systems.

In another embodiment, the system can include the use of a hypervisor or other hardware-enabled privileged state, providing additional local protection and context for the detection and prevention algorithm. This embodiment can use secure sensors and/or software protection mechanisms designed to be robust against kernel-level compromise.

The system can be implemented on any computing device that receives user events and generates system events. Non-limiting examples of the types of devices on which the system can be implemented include servers, desktops and laptop computers running any one of various operating systems, as well as any type of mobile computing device.

Some embodiments of the system can include advanced anti-spoofing technology effected by a hypervisor to protect the software and sensors from tampering or malware attacks that would attempt to circumvent the detection engine.

The system does not require traditional signature-based detection techniques. Thus, the system and algorithm are able to detect and stop previously unknown types of attack.

System Architecture

Detection Algorithm

If a communications connection is attempted by a user application that is neither initiated by the user nor is the direct result of a user-initiated process, then it may be assumed to be the driven by malicious software. User-driven inputs to an application that result in outbound communication traffic demonstrate user intent to transmit data. By parsing and evaluating user driven inputs, the system can detect legitimate user-driven file and data interactions. As non-limiting examples, inputs processed in connection with the detection analysis can include inputs from any HMI devices, as well as actions relating to HMI devices, such as the selection of files in an upload menu, command line FTP arguments, or using a mouse to drag files into a new folder. These types of inputs from HMI devices as well as actions relating to HMI devices are referred to as user events.

Additionally, the system can track the amount of time that passes between user-driven inputs and communication connection requests in order to infer valid user intent and to potentially generate and verify simple behavioral biometric fingerprinting of users.

In order to reduce the likelihood that HMI sensor input and events could be forged through malicious tampering, the HMI sensors can also be protected by privileged state code such as that instantiated through a hypervisor.

An example malicious behavior detection algorithm can be comprised of some or all of the following components and steps.

a: There may exist a dynamic list of applications currently allowed and expected to make connections. Application entries contain identification and state information for use in behavioral analysis. This information can include: user input process identification number, user input process name, user input event count (with separate counters for each discrete input source), communication event count (with separate counters for each discrete communication source), and timeout or expiration information.

b: New applications enter the application list when they receive valid user input as defined by the earlier methodology of input validation and verification. Applications are then kept on the list until the timeout has expired, balancing the burden of adding new applications with the requirement to closely manage security by minimizing the window of exposure through applications on the list. An application expiration period, once on the list, can be dynamically extended when the system recognizes additional validated user communication activity. The expiration can also be adjusted by an appropriate period when an inherently longer user activity request event is received, in order to allow for periods of user inactivity that are expected in operations like long downloads or streaming applications. Applications are removed from the approved active list once the connection expiration has elapsed.

c: Communication activities requests that occur when the requesting application is not on the active list can trigger an alert or take a preconfigured action.

d: Other forms of detection can also be performed, based on contextual analysis including detection of active forged manipulation of screen objects, such as dragging a file within Windows, or executing remote transfers such as FTP from a command line. Malicious code can impersonate an active user, including impersonation of these types of events, which can, in turn, provide mechanisms for unauthorized hostile behaviors.

In-VM to Out-VM Communication

Turning now to FIG. 4, in order to share information between the In-VM and Out-VM components, the implementation can include a custom API that will maintain a pre-defined trapping event. An example would be that specific calls or operating system events, such as a virtual memory reference (VMMCALL instruction) or faults, would be recognized and acted upon by Out-VM components. In this example, the Out-VM component is a hypervisor 126, with the VMMCALL instruction in receiving hypervisor DLL 136.

The operating system (OS) 120, via its In-VM component 124 (FIG. 1), monitors events created by both user and network inputs, sending these events to the Out-VM components. Again, in this case, the Out-VM component is the Hypervisor DLL 136. When an event is received through the DLL, the hypervisor appends the timestamp of the last associated hardware event as received from the thin hypervisor (hardware component) 126 below. By monitoring API and user input from within the OS, the detection system can identify the process with which an event is associated. The process identification number can then be used by the algorithm to associate events with the process and with each other. A timestamp is also recorded to be compared to the value received by the hardware I/O monitor based in the hypervisor.

Hypervisor-based application protection of In-VM application memory space.

The system can be configured so that malware cannot forge user events or data in order to circumvent the monitoring system and so that the system can identify applications and user events related to outgoing data and incoming network connections directly related to the execution of the malicious behavior.traffic. This relationship between actual user device behavior and system requested resources or actions is a clear differentiator between active processes and potential automated malicious code that is posing as an actual user.

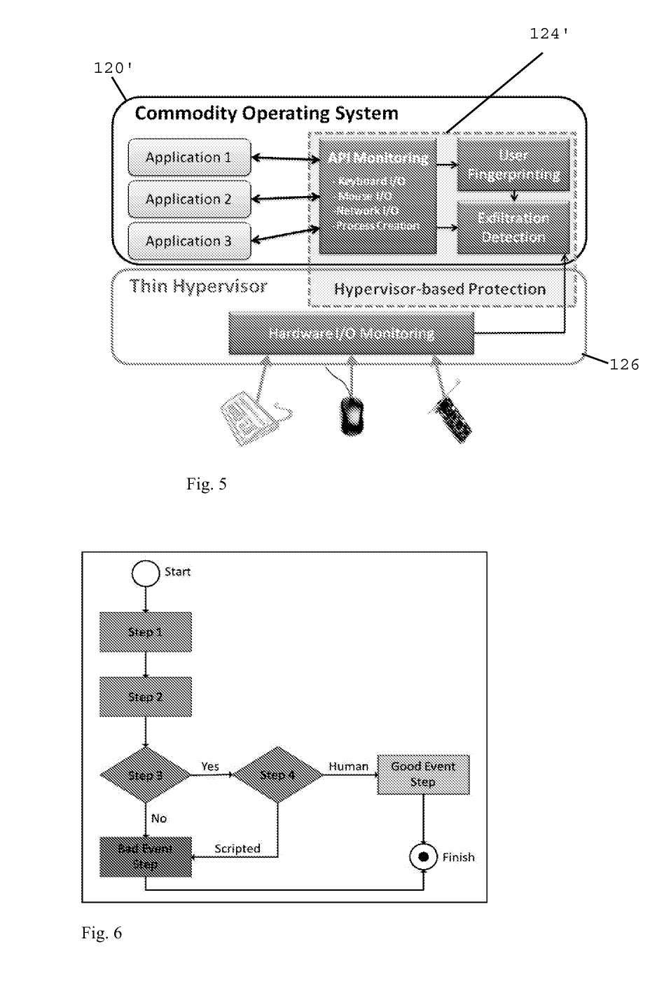

An example of this type of hypervisor-based protection of the system and events is illustrated in FIG. 5. While FIG. 5 includes a mouse and a keyboard, the system can be configured to monitor any form of user input that can be electronically represented. As a non-limiting example, some embodiments can be implemented on a smartphone that uses the touchscreen and/or Bluetooth headset as user input sensors, and instrumented outbound connection points can include communications by, for example, Wi-Fi, NFC, Bluetooth, 3G/4G, etc.

In-VM monitoring: The VM (in this case represented by the user interface application/user validation engine 124′ of Commodity Operating System 120′) can be configured to capture user events, including information relating to the keyboard and mouse through API keyboard I/O events and API mouse I/O events.

Out-VM monitoring: In this example, a thin hypervisor 126 is performing pass-through information gathering and monitoring of actual hardware device IO. This will provide the verification information necessary to validate events as originating with the user at an actual hardware device.

The In-VM Keyboard and Mouse Monitors of user validation engine 124′ can include separate DLLs which are loaded into every process on the system that can accept input from either the keyboard or mouse. Once loaded, any event that is destined for an application will be intercepted. When events arrive at the hook function they will be copied into a structure along with the current time in ticks, and the process identification number (PID).

That user event information, as presented through the In-VM components, is then passed to the Out-VM component (in this case the hypervisor) for verification through checks against the actual device events as recorded in hardware I/O.

### Example

### User vs. Malware Identification Communication Request Validation

Unauthorized exfiltration of data depends upon the ability of the malicious processes to establish network communications for performing the actual data transfer. In this example, the implementation of the earlier described approach, for the purposes of validating and enabling authorized connections (or denying unauthorized connections) is described.

As discussed in greater detail herein below, the Approved Process List (APL) may be used to maintain a current view of processes which are actively interacting with human users for the purpose of quickly distinguishing between authentic and forged user event transactions for resources.

The assessment of this validity is the precursor to establishment of any communications, and that validation, currently implemented using the foregoing approach, is the subject of this example.

In particular embodiments, the APL is maintained in conjunction with its inverse, the Rejected Process List (RPL). At a high level, one can view the universe of processes that are running as a system as either falling into one of these two lists, into a list that is composed of those processes which are not generating user events of the types that would force the system to evaluate user and device behaviors for authenticity, or into an exception list that is created to contain processes which are expected to have longer delays or otherwise anomalous event/action behaviors. In this last case, steps are taken to ensure that, as an example, longer-lived processes have additional restrictions upon the types of operations they are allowed to perform such as limiting the scope of their operations or specific time constraints for approved actions from the process.

In order to maintain a current view of these lists, which is central to associated device events and user event requests, processes that are involved in producing either a user event or a system event, including any keyboard, mouse, or network events, undergoe the following analysis. When a user interface application receives an event, that event is analyzed to acquire the data necessary to create or update a tracking state storage mechanism which is referred to as the process_node structure. The structure of the process_node is given below in Table I, for the example of an event likely to involve user-driven events from mouse, keyboard and network devices:

TABLE I

```
struct process_node {
      unsigned long process_id;
      char process_name[MAX_PROCESS_NAME_SIZE];
      unsigned long number_mouse_events;
      unsigned long number_keyboard_events;
      unsigned long number_network_events;
      unsigned long long expiration;
};
```

This information is then fed into a User Input Event Analysis process (user validation engine 124, 124′) that follows the steps described as follows and as shown in FIG. 6:

Step 1:

Event Integrity Check: This optional step involves ensuring that the expected format and content types of the event are followed in the event received.

Step 2:

Add the event to user validation engine: As mentioned, there are multiple types of validation possible, and in this example, the algorithm seeks to ensure that apparent user-generated events are actually being generated by a human user through one of the named devices, and are not being created by a process controlled by some automated or remote means.

Step 3:

Confirm whether the delta between the hypervisor and OS event time is less than the pre-determined “hypervisor to operating system delta”, i.e., is less than the timeout/expiration period: The user event is constructed as described, and one of the values passed is the expiration value for that specific event.

Step 4:

Get user validation engine score to determine if the input was a human or script (i.e., forgery): The user validation engine measures the amount of time between device events and compares that to the limit passed on process expiration, yielding a Boolean true/false answer based on the amount of time that has passed between the last event generated by an actual hardware device and the user event that has just been initiated by the subject process. If the amount of time is greater than the expectation of expiry, then the process is known to be non-user generated.

Good Event Step:

Add or move the process node to the APL. If the process is already on the list, the expiration is updated with the event time plus the earlier-mentioned communications activity timeout, as is the counter for the related device event. If the process is not already on the list then the node is created and initialized with the event PID and Process Name. Then the “Number of User Input Events” field is incremented accordingly. The expiration is initialized with the approved communications activity timeout.

Bad Event Step:

Add or move the process node to the RPL: If the process is already on the list, then the expiration (remove from rejected list) timeout is updated and the “number of User Input Events field” is decremented. If the process node did not exist previously, then the node must be created and initialized with the event PID, Process Name, Event Count, and Expiry.

Differentiating Values

In an example of Step 3 (FIG. 6), the algorithm takes as input the delay between the last valid user input to an application and the time at which communications connections are established. This can be based on analysis of the individual events as well as their relationship to particular processes. Once events have been separated on a per process basis they are inspected to indicate if suspicious activity is taking place. Observation has shown that acceptable application communications usage occurs within a predictable time span following valid user input to an application.

It is important to note at this time that the verification information, as provided to the hypervisor and analytics components of this analysis, is both generated by the underlying Out-VM component (the thin hypervisor), and is protected by Out-VM components to ensure its own integrity.

If both the timing and relation requirements are not met, an instance can still be deemed acceptable if the occurrence is listed on the exception list. The exception list is used to rule out particular processes identified as allowed to initiate communications traffic without a correlating user input event (e.g., system automatic updates, system daemons and system services) that would otherwise be flagged by the algorithm.

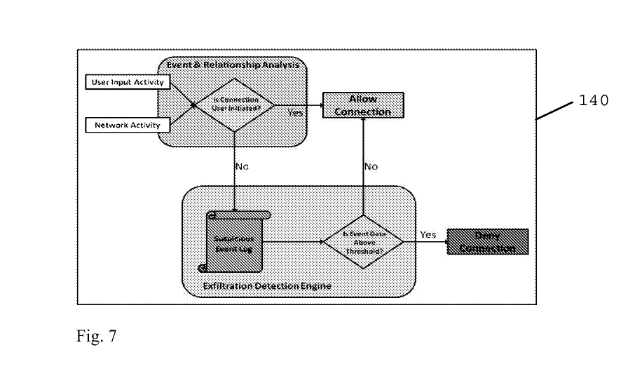

An overview of an exemplary total communication/connection algorithm 140 is illustrated in FIG. 7.

The algorithm of FIG. 7 may be abstracted to the statement below. If the equation below evaluates to true, then the connection is permitted. Otherwise, it is flagged as suspicious.

(WithinSeconds AND InputRelated) OR IsException

The following section further describes the data components of a particular embodiment of an algorithm usable in the methods of FIGS. 6 and 7, that has been documented, and which is represented by this simplified statement:

WithinSeconds

Once parsed, the various input timestamps are converted to seconds. The user action input time is subtracted from network or communications time and compared to the target seconds. Communications traffic is valid if the result is both less than the target number of seconds (expiry) and a nonnegative number. (The number must be positive because a negative number implies that the input occurred after the communications connection was already established.) This comparison is made with network and/or communication events against any type of user input events. While this example uses seconds for measurement, any other unit of time could clearly be used.

A non-limiting example for interaction between user, communications network, mouse and keyboard is provided below:

TargetSeconds=Target input and communications correlation (or expiry)

WithinSeconds=[0<(NetworkSeconds−MouseSeconds)<TargetSeconds] OR [0<(NetworkSeconds−KeyboardSeconds)<TargetSeconds]

InputRelated

Data is collected and logged for network or communications connections that are made and network or communications entries are linked to a running process. In this case, the value of “Input Related” is defined as the union of both related Keyboard and Mouse process identifying information.

InputRelated=(NetworkProcess==KeyboardProcess) OR (NetworkProcess==MouseProcess)

IsException

The BasicExceptionList contains a listing of acceptable applications. Adding an item to this list can reduce false positives but may increase the possibility of false negatives (malware connections could be made through the whitelisted programs). The DetailedExceptionList contains a list of acceptable occurrences that can be matched to several fields such as process, operation and path. If an entry is listed on either list, it is an acceptable occurrence and will not be flagged by the algorithm.

OnBasicExceptionList=(NetworkProgram==BasicException)

OnDetailedExceptionList=(NetworkEntry==DetailedException)

IsException=OnBasicExceptionList OR OnDetailedExceptionList

There are a variety of programs that may warrant entries in the whitelist. As non-limiting examples, the whitelist can include typical system services such as spoolsv.exe, svchost.exe, services.exe and lsass.exe. Automatic updates from various programs can be allowed by dynamically adding occurrence exceptions to the detailed exception list. This framework adapts to newly installed software by adding basic or detailed exceptions.

For all entries that exist within the ExceptionList structure, additional constraints are applied in order to mitigate the threat and likelihood of exploit from generic or typical system services. Non-limiting examples of these constraints would include exposition of process ownership and provenance, execution path, or port number associated with any external network request from the named service.

Outcome of Implementation

Following this algorithm and implementation, malicious processes which attempt to exfiltrate data through generation of forged user events fail. The processes themselves are flagged as rejected, and the opportunity is presented to send context about their existence and behavior to other monitoring systems.

This implementation does not penalize approved processes through a streamlined implementation of approved process validation and maintained current approved process list.

As discussed hereinabove, in various embodiments, the user validation engine can be used to determine if input events were generated by a program or a human by analyzing the amount of time between an event's initialization and completion. The sensor can target input devices (such as keyboard and mouse input) by examining the time between inputs (such as key presses and releases). This reduces the ability of advanced malware to spoof input sensors. The system can compare operating system and hypervisor timestamps for each user input event. If events do not match, or the delta is too large, then the event was not generated by hardware, such as shown in Table II.

TABLE II

| Function | Description |
|---|---|
| int recordEvent( int eSource, | Records the given event and |
| int state, int time ) | the time in milliseconds at |
| | which it occurred. |
| int getScoreBoolean( [int window] ) | Retuns a boolean 1 or 0 where |
| | 1 corresponds to human |
| | activity, and 0 corresponds |
| | to scripted activity. |
| double getScoreScale( [int window] ) | Returns a floating point value |
| | between 0.0 and 1.0 corresponding |
| | to the likelihood of whether a |
| | set of actions is human or not, |
| | where 0.0 is very unlikely and |
| | 1.0 is very likely. |

A more detailed, non-limiting example of an embodiment using a combination of in-VM and Out-VM (hypervisor) based components as shown in FIG. 1 is as follows.

A. In-VM Application Configuration

A.1. High Level Operating System Keyboard Monitor. In some embodiments, this can use a Windows Hook API. Keyboard events can be passed to the hypervisor with a timestamp (ticks), process identification number, key and state.

A.2. High Level Operating System Mouse Monitor. In some embodiments, this can use a Windows Input Hook API. Mouse events can be passed to the hypervisor with a timestamp (ticks), process identification number, button and state.

A.3. Operating System Communications Monitor. This monitor can be configured to use a custom DLL wrapper to intercept communications traffic. Calls to a send, transmit, transfer, or any other type of communications function can be intercepted passed to the hypervisor with a timestamp (ticks), process identification number and function identifier.

A.4. User Interface Application

The user interface application can include a user interface in an In-VM process for controlling the detection system. This can include starting and stopping the hypervisor, OS monitors and analyzing data received in real-time. It can also include real-time notification of events, exfiltration attempts, logging, installation, de-installation of the different components, and algorithm manipulation. This application can be protected by the hypervisor's process protection module.

The user interface application can be used to configure at least the following aspects of the system.

A.4.a. Hypervisor: Install/uninstall hypervisor, notify In-VM monitors when the hypervisor is available, poll hypervisor for monitor events.

A.4.b. Monitors (user input, e.g., keyboard, mouse, communications): activate/deactivate In-VM monitors.

A.4.c. Logging: Log events to the screen and/or a file, log process movement to the screen and/or a file, log data exfiltration attempts to the screen and/or a file.

A.4.d. Changeable Variables: User-fingerprinting window (number of events to use), remove from rejected list timeframe, user interaction to communications activity timeframe, communications access extension.

A.4.e. Miscellaneous: Print current ticks in seconds (useful to compare expirations in approved and rejected process lists), print user-fingerprinting score (useful when user wants to see if current input is considered scripted or human), list currently approved and rejected processes.

The system can include a graphical user interface (GUI) based notification system configured to create pop-ups on data exfiltration attempts and other events. A taskbar icon could be used to identify the state of the system. The system can be configured so that right-clicking on an icon would bring up a menu which will be utilized to install/uninstall, activate/deactivate, start/stop and modify the detection subsystems.

B. Out-of-VM Hypervisor

The hypervisor provides a tamper resistant core that executes out-of-band from other system software, hardening the detection system from being tampered with, modified or disabled by user- or kernel-level malware. Hardware I/O is captured from within the hypervisor and is used to verify events that are detected from within the OS. The process and memory protection mechanisms can be implemented using a hypervisor technique such as multi-shadowing. The result is protection is harder to defeat, even in the face of complete kernel compromise.

In-VM applications can communicate by using an agreed upon API and the VMMCALL instruction which can trap to the hypervisor. The operating system monitors (e.g., keyboard, mouse, and/or communications) send events to the hypervisor. When an event is received, the hypervisor appends the timestamp of the last associated hardware event (e.g., keyboard, mouse, and/or communications). Events can be passed from the monitors to the hypervisor in registers.

B.1. Low Level Hypervisor Input Monitor

The hypervisor can contain multiple modules, including a communications monitor, input monitor (e.g., keyboard monitor, mouse monitor) and process/page protection. The modules can provide a communication path and functionality to specific In-VM components. The hypervisor communicates with both the In-VM application and the In-VM OS monitors. As a non-limiting example, other hypervisors (e.g., ones for Intel ARM, etc., may use another instruction to construct this interface). Any hypervisor based trapping event can be used (exceptions, interrupts, faults, etc.)

The In-VM components can communicate using parameters placed in general purpose registers (GPRs). The interface can utilize the EAX register to identify which module with which to communicate. The rest of the GPRs are used for parameter passing and are specific to each module. The different modules available for communication are defined below in Table III.

TABLE III

| | |
|---|---|
| #define VMMCALL_TEARDOWN | 0x00000001 |
| #define VMMCALL_PROCESS_PROTECTION | |

0x00000002

#define VMMCALL_GET_SIGNATURE

0x00000003

| | |
|---|---|
| #define VMMCALL_KEYLOGGER | 0x00000004 |
| #define VMMCALL_NETWORK_MONITOR | |

0x00000005

#define VMMCALL_KEYBOARD_MONITOR

0x00000006

#define VMMCALL_MOUSE_MONITOR

0x00000007

The communications, input (e.g., keyboard and mouse) monitors can use the EBX register to identify what action has been requested, such as adding an event, removing events, getting the number of stored events or clearing the stored events. The input monitors focus on the examination of PS/2 devices, which is accomplished using the Port I/O Sensor module.

In order to verify user input events the input monitors can collect accurate timestamps from when those events occur. The “Read Time Stamp Counter” (RDTSC) instruction can be used for this and returns a 64-bit value indicating the number of processor cycles that have passed since the system was powered on. This represents a high precision timer sufficient for supporting the required verification. Using the RDTSC instruction and extending the Port I/O Sensor module, the Out-of-VM monitors are able to keep track of recent PS/2 based keyboard and mouse input received from the hardware.

Events can be stored using independent circular buffers, one for each of the monitors. These buffers are statically allocated and have a maximum size, and when completely filled will start to overwrite the oldest events first. A static allocation can be used.

Process/page protection can be accomplished with the AMD/SVM architecture nested.

Whenever another process or the OS kernel tries to access the page, garbage is returned. If the protection was for a process the page will be mapped in correctly when the process is executing and mapped to garbage otherwise. The process/page protection module also has the ability to make pages as not present which will result in a nested page fault and pass execution to the hypervisor, which will allow for VM inspection.

These features can be used to protect the system, including the In-VM user interface application and make the hypervisor invisible to the OS. The system can map the pages it resides on out so the OS is unable to discover it.

System Implementations

The system can be implemented in any operating system, including as non-limiting examples, Windows, MacOS, iOS, Android and Linux. The optional hypervisor can be configured to support Intel VT architecture and AMD SVM architectures and provide the described functionality on both AMD and Intel CPUs to cover a wide variety of PC configurations. The system can also be implemented using ARM VE or with a microvisor on a CPU that does not support virtualization extensions.

The system can also be instantiated by dynamically hoisting the running operating system into a virtual machine.

Variables

Various different parts of the algorithms can be altered. This gives the user the ability to increase or decrease security at runtime. Changing the default values could increase or decrease security and concurrently increase or decrease false-positive rates.

As a non-limiting example, if the “Approved Communications Access Timeout” is modified to only consider communications connections within 1 millisecond of user input, a legitimate application may not have enough time to make a communications connection, and consequently the connection would be seen as a data exfiltration attempt.

Any of the variables listed below have the ability to cause this kind of false-positive event.

User Validation Engine Window (Determines how many events to take into consideration when deciding if the event was user- or script-created).

Hypervisor to Operating System Delta (Limit on how long it can take an event to propagate from the hardware to the OS Monitor).

Approved Communications Access Timeout (Limit on how long an application has to make a legitimate communications connection).

Remove From Rejected List Timeout (How long an application is stored in the rejected list before it is purged).

Poll Events Interval (Limit to when the optional hypervisor should be asked for events).

Additional Sensors/Monitors

In addition to monitoring user input and communications, other system resources can also be monitored.

Registry

In Microsoft Windows operating systems, the registry can be used for a variety of tasks, including, for example, identifying startup services, loading device drivers, and/or storing application and OS specific data. Due to the wealth of information available and the ability start/load drivers and services, the registry is an attractive target for access and manipulation by malware. Monitoring the API used to access the registry allows the detection system to be augmented and gain insight into what a particular process is doing. Correlating the registry information with that obtained from a communications API provides additional information to the data exfiltration detection engine.

Similar constructs exist among all operating system platforms, including but not limited to Apple OSX, IOS, Linux, and Android.

File System

A local or network file system is often used to store sensitive information. Applications that have a large amount of file system activity and communications activity can be considered potentially harmful and may be harvesting data. By monitoring such file system activity, the detection algorithm can identify processes that may be aggregating data with the future intent to remove it from the system.

Miscellaneous API

Other API functions have been identified as commonly used by malicious software. These functions can also be monitored and can provide an indication to the detection engine that a trusted process may no longer be trustable. Windows provides an API that allows for the allocation of memory in remote processes as well as the ability to create a thread in other arbitrary processes. Combined, these APIs can be used to inject code and start execution in other processes. This technique could be utilized to separate data harvesting methods and the exfiltration channel. For example, a process could be used to gather data from the registry, memory and/or persistent storage mediums and then use the newly created remote thread, which could be in a process approved for communications access, to exfiltrate the data. The detection system described herein can be used to monitor malicious code that would be able to migrate between them. These miscellaneous monitors can provide that functionality.

System Architectures

The systems and methods described herein can be implemented in software or hardware or any combination thereof. The systems and methods described herein can be implemented using one or more computing devices which may or may not be physically or logically separate from each other. Additionally, various aspects of the methods described herein may be combined or merged into other functions.

In some embodiments, the illustrated system elements could be combined into a single hardware device or separated into multiple hardware devices. If multiple hardware devices are used, the hardware devices could be physically located proximate to or remotely from each other.

The methods can be implemented in a computer program product accessible from a computer-usable or computer-readable storage medium that provides program code for use by or in connection with a computer or any instruction execution system. A computer-usable or computer-readable storage medium can be any apparatus that can contain or store the program for use by or in connection with the computer or instruction execution system, apparatus, or device.

A data processing system suitable for storing and/or executing the corresponding program code can include at least one processor coupled directly or indirectly to computerized data storage devices such as memory elements. Input/output (I/O) devices (including but not limited to keyboards, displays, pointing devices, etc.) can be coupled to the system. Network adapters may also be coupled to the system to enable the data processing system to become coupled to other data processing systems or remote printers or storage devices through intervening private or public networks. To provide for interaction with a user, the features can be implemented on a computer with a display device, such as an LCD (liquid crystal display), or another type of monitor for displaying information to the user, and a keyboard and an input device, such as a mouse or trackball by which the user can provide input to the computer.

A computer program can be a set of instructions that can be used, directly or indirectly, in a computer. The systems and methods described herein can be implemented using programming languages such as Flash™, JAVA, C++, C, C#, Visual Basic™, JavaScript™, PHP, XML, HTML, etc., or a combination of programming languages, including compiled or interpreted languages, and can be deployed in any form, including as a stand-alone program or as a module, component, subroutine, or other unit suitable for use in a computing environment. The software can include, but is not limited to, firmware, resident software, microcode, etc. Protocols such as SOAP/HTTP may be used in implementing interfaces between programming modules. The components and functionality described herein may be implemented on any desktop operating system executing in a virtualized or non-virtualized environment, using any programming language suitable for software development, including, but not limited to, different versions of Microsoft Windows™, Apple™ Mac™, iOS™, Unix™/X-Windows™, Linux™, etc. The system could be implemented using a web application framework, such as Ruby on Rails.

The processing system can be in communication with a computerized data storage system. The data storage system can include a non-relational or relational data store, such as a MySQL™ or other relational database. Other physical and logical database types could be used. The data store may be a database server, such as Microsoft SQL Server™ Oracle™, IBM DB2™, SQLITE™, or any other database software, relational or otherwise. The data store may store the information identifying syntactical tags and any information required to operate on syntactical tags. In some embodiments, the processing system may use object-oriented programming and may store data in objects. In these embodiments, the processing system may use an object-relational mapper (ORM) to store the data objects in a relational database.

Suitable processors for the execution of a program of instructions include, but are not limited to, general and special purpose microprocessors, and the sole processor or one of multiple processors or cores, of any kind of computer. A processor may receive and store instructions and data from a computerized data storage device such as a read-only memory, a random access memory, both, or any combination of the data storage devices described herein. A processor may include any processing circuitry or control circuitry operative to control the operations and performance of an electronic device.

The processor may also include, or be operatively coupled to communicate with, one or more data storage devices for storing data. Such data storage devices can include, as non-limiting examples, magnetic disks (including internal hard disks and removable disks), magneto-optical disks, optical disks, read-only memory, random access memory, and/or flash storage. Storage devices suitable for tangibly embodying computer program instructions and data can also include all forms of non-volatile memory, including, for example, semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

The systems, modules, and methods described herein can be implemented using any combination of software or hardware elements. The systems, modules, and methods described herein can be implemented using one or more virtual machines operating alone or in combination with each other. Any applicable virtualization solution can be used for encapsulating a physical computing machine platform into a virtual machine that is executed under the control of virtualization software running on a hardware computing platform or host. The virtual machine can have both virtual system hardware and guest operating system software.

The systems and methods described herein can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks that form the Internet.

One or more embodiments of the invention may be practiced with other computer system configurations, including hand-held devices, microprocessor systems, microprocessor-based or programmable consumer electronics, minicomputers, mainframe computers, etc. The invention may also be practiced in distributed computing environments where tasks are performed by remote processing devices that are linked through a network.

While one or more embodiments of the invention have been described, various alterations, additions, permutations and equivalents thereof are included within the scope of the invention.

In the description of embodiments, reference is made to the accompanying drawings that form a part hereof, which show by way of illustration specific embodiments of the claimed subject matter. It is to be understood that other embodiments may be used and that changes or alterations, such as structural changes, may be made. Such embodiments, changes or alterations are not necessarily departures from the scope with respect to the intended claimed subject matter. While the steps herein may be presented in a certain order, in some cases the ordering may be changed so that certain inputs are provided at different times or in a different order without changing the function of the systems and methods described. The disclosed procedures could also be executed in different orders. Additionally, various computations that are herein need not be performed in the order disclosed, and other embodiments using alternative orderings of the computations could be readily implemented. In addition to being reordered, the computations could also be decomposed into sub-computations with the same results.

1. A system for detecting the existence of malicious software on a local host based on an analysis of software process behavior including an analysis of user input events with respect to system events, the system comprising:
a computer including a processor, a memory, an operating system (OS), and one or more Human Machine Interface (HMI) devices, the computer having a hardware level communicably coupled to the HMI devices, a kernel process level within the OS, and an Application/Application Programming Interface (API) level for executing applications;
a user interface application including a user validation engine executable by the processor to provide user notification, interaction and analysis; and
one or more In-VM operating system monitors communicably coupled to the OS and configured to capture input and communication events handled by the OS;
the In-VM operating system monitors configured to capture user input from the HMI devices, and to capture system events from applications executed by the processor, at one or more points at the hardware level, the kernel process level, and/or the API level;
the In-VM operating system monitors configured to pass the captured user input and system events to the user validation engine for analysis;
the user validation engine configured to identify legitimate user events as those that start at the hardware level and move upward to one or more pre-selected applications;
the user validation engine configured to identify illegitimate user events as those that start at the kernel process level and/or the API level;
the user validation engine further configured to approve communication for legitimate user events and to deny communication for illegitimate user events.

2. The system of claim 1, further comprising one or more Out-VM components communicably disposed between the OS and the HMI devices, the Out-VM components configured to provide event verification used in the detection of attempted unauthorized exfiltration of data based on an analysis of user input events with respect to system events.

3. The system of claim 2, wherein the one or more Out-VM components comprise a hypervisor configured to append verification data to the user event and to store user event data until requested by the user interface application.

4. The system of claim 2, wherein the user interface application is configured to poll the hypervisor for user event data at a predetermined interval.

5. The system of claim 2, wherein the hypervisor comprises a thin hypervisor including a hardware-enforced sub-kernel level layer configured to provide hardware input/output (I/O) monitoring and protection for in-VM components.

6. The system of claim 2, comprising HMI sensors protected by privileged state code instantiated through the hypervisor.

7. The system of claim 2, wherein the In-VM components are configured to pass the captured user input and system events to the Out-VM components for verification.

8. The system of claim 1, wherein the hardware devices include one or more of keyboard, mouse, touchscreen, touchpad, accelerometer, and/or proximity sensors.

9. The system of claim 1, wherein the user validation engine comprises a software application running with kernel privileges.

10. The system of claim 1, wherein the user validation engine is configured to monitor user events and system events to determine presence of a correlation between the user events and system events, the presence of a correlation indicative of validity of the user event.

11. The system of claim 10, wherein the user validation engine is configured to distinguish between legitimate communications connections intended by the user and automated communications connections established by malicious programs, and to then prevent outgoing traffic or data transfers that are not initiated or authorized by an actual user controlled process.

12. The system of claim 10, wherein the user validation engine is configured to distinguish between legitimate communications connections intended by the user and automated communications connections established by malicious programs, and to then prevent incoming traffic or data transfers to the malicious programs.

13. The system of claim 10, wherein the user validation engine is configured to monitor user events including actuation of HMI devices and actions relating to HMI devices, including selection of files in an upload menu, command line FTP arguments, and/or using a mouse to drag files into a new folder.

14. The system of claim 10, wherein the user validation engine is configured to monitor system events including inter-device communications, file system input/output, activation of windows, files accessed, API calls related to functions, interprocess communications, and combinations thereof.

15. The system of claim 10, wherein the user validation engine is configured to track the amount of time that passes between user-driven inputs and communication connection requests in order to infer valid user intent.

16. The system of claim 10, wherein the user validation engine is configured to maintain an Approved Process List (APL) in the form of a dynamic list of applications currently allowed and expected to make connections, the list including identification and state information for each application.

17. The system of claim 16, wherein the APL includes one or more of: a user input process identification number; a user input process name; a user input event count; a communication event count; and an application timeout or expiration period.

18. The system of claim 17, wherein the user validation engine is configured to permit new applications to enter the APL upon said determination of a correlation between user events and system events.

19. The system of claim 18, wherein the user validation engine is configured to keep applications on the APL until the application timeout or expiration.

20. The system of claim 19, wherein the user validation engine is configured to dynamically extend the application timeout or expiration upon recognition of additional validated user communication activity.

21. The system of claim 10, wherein the user validation engine is configured to maintain a Rejected Process List (RPL) in the form of a dynamic list of applications currently not permitted and not expected to make connections.

22. A method for detecting exfiltration of data based on an analysis of user input events with respect to system events, the method comprising using the system of claim 1 to:
(a) capture, with the In-VM operating system monitors, user input from the HMI devices, and system events from applications executed by the processor, at one or more points at the hardware level, the kernel process level, and/or the API level;
(b) pass, with the In-VM operating system monitors, the captured user input and system events to the user validation engine for analysis;
(c) identify, with the user validation engine, legitimate user events as those that start at the hardware level and move upward to one or more pre-selected applications;
(d) identify, with the user validation engine, illegitimate user events as those that start at the kernel process level and/or the API level;
(e) approve, with the user validation engine, communication for legitimate user events; and
(f) deny, with the user validation engine, communication for illegitimate user events.
